(19) United States
(12) Patent Application Publication
(10) Pub. No.: US 2003/0139693 A1
(43) Pub. Date: Jul. 24, 2003

(54) Dental massage chair

(76) Inventor: Mary Swift, Dallas, TX (US)

Correspondence Address: CARSTENS YEE & CAHOON, LLP, P O BOX 802334, DALLAS, TX, 75380

(21) Appl. No.: 10/348,247

(22) Filed: Jan. 21, 2003

Related U.S. Application Data
(60) Provisional application No. 60/351,086, filed on Jan. 22, 2002.

(51) Int. Cl. A61H 23/00

(52) U.S. Cl. 601/15; 601/49; 601/70

(57) ABSTRACT

The present invention comprises a dental chair providing for patient support and sensory stimulation to provide a more comfortable and relaxing patient environment while undergoing dental examination and treatment. Specifically, the invention comprises lifting and tilting mechanisms as generally known in the art and incorporates a series of massaging vibratory devices, inflatable pillow supports and audio speakers placed within the chair. A control pad is provided enabling the patient to control the sensory input while the patient is undergoing a dental procedure.

### RELATED APPLICATION

The present invention claims priority to provisional patent application Serial No. 60/351,086, filed on Jan. 22, 2002.

### BACKGROUND OF THE INVENTION

1. Technical Field

The present invention generally relates to an adjustable dental examination chair and, more specifically, to a dental chair which provides massage therapy and sensory stimulus to the patient in the chair.

2. Description of Related Art

Many different types of adjustable chairs have been developed to aid persons in the medical arts in performing patient examinations and treatments. Motorized examination chairs are used in a wide variety of medical fields, including surgical chairs, dental chairs and ophthalmic examination chairs. For example, U.S. Pat. No. 6,106,065 (Carroll) discloses a lift and tilt chair with motorized lift and tilt capabilities. U.S. Pat. No. 5,467,002 (Brooks) discloses an adjustable chair with programmable control switches. Both of these chairs contain features to provide medical personnel with the ability to orient the patient in the chair into a position which facilitates medical treatment and/or diagnosis.

Although various improvements with respect to the actuation and control of dental and medical examination chairs have been made over the past years, certain undesirable aspects associated with prior art chair designs have remained embedded in those designs. For example, the cited prior art does not address a mechanism by which to provide for increased muscular and emotional comfort to the patient while undergoing dental examination or treatment. Likewise, the prior art does not address a mechanism by which to provide alternative sensory stimulus to a patient via the chair while the patient is undergoing examination or treatment. Thus, a need exists for an adjustable dental chair equipped to provide a patient with sensory stimulus while undergoing dental examination and treatment.

### SUMMARY OF THE INVENTION

The present invention comprises a dental chair providing for patient support and sensory stimulation to provide a more comfortable and relaxing patient environment while undergoing dental examination and treatment. Specifically, the invention comprises lifting and tilting mechanisms as generally known in the art and incorporates a series of massaging vibratory devices, inflatable pillow supports and audio speakers placed within the chair. The massaging centers provide selectable massaging action to the patient's body while the patient occupies the chair. The inflatable supports provide neck, lumbar and knee support to the patient along with selectable heat therapy to neck, lumbar and knee areas. The sound speakers located within the headrest portion of the chair provide soothing sounds for the patient to enjoy while the patient occupies the chair.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 illustrates a perspective view of the dental massage chair invention disclosed herein;

FIG. 2 illustrates in further detail the control pad for the dental massage chair invention disclosed herein; and,

FIG. 3 is a top view of the dental massage chair invention disclosed herein.

### DETAILED DESCRIPTION OF THE PREFERRED EMBODIMENT

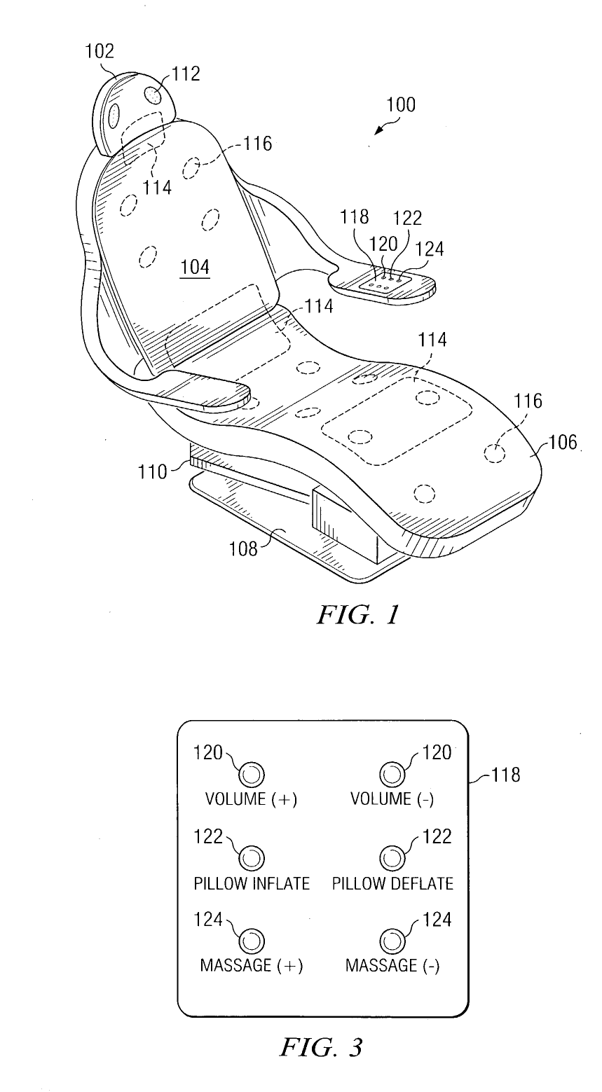

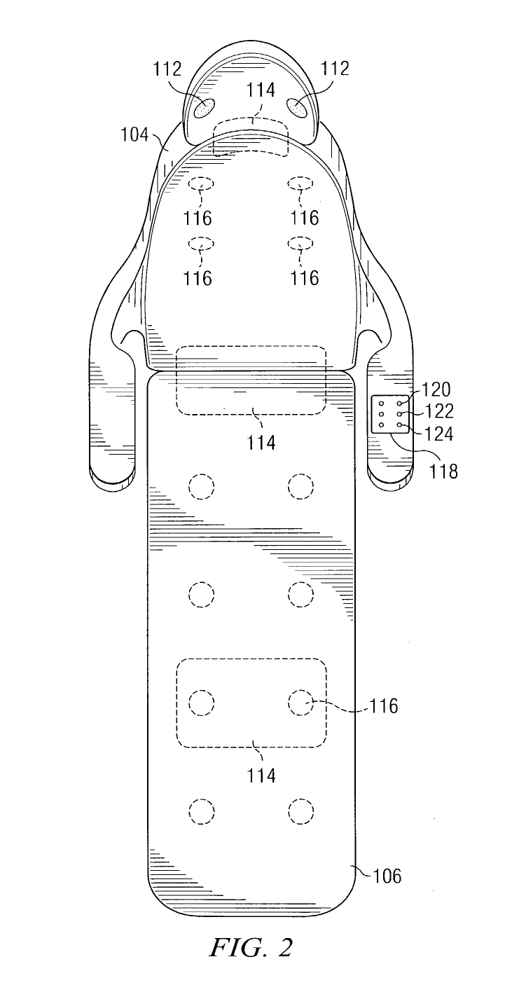

FIGS. 1 and 2 illustrate a chair 100 with a base support 108 affixed to tilting and lifting mechanisms 110 which provide for movement and orientation of the patient as desired during medical procedures. The chair 100 further comprises a headrest 102, a backrest portion with attached armrests 104, and a leg rest 106. Chairs providing for the lifting and orientation of a patient are well known in the art as described in U.S. Pat. No. 6,106,065 and U.S. Pat. No. 5,467,002, the disclosures of which are incorporated herein by reference. Sound speakers 112 are located within chair headrest 102 and are positioned so as to comfortably allow the patient to listen to audio programming while positioned in the chair 100. The audio programming may be supplied to the chair speakers 112 by a wired or wireless connection as known in the art. Massage centers 116 are positioned within chair 100 to provide massaging action to the patient's shoulders, lower back, buttocks, thighs, knees and calve areas while the patient is positioned in the chair 100. Inflatable pillows 114 are positioned at the neck, lower back and knee to provide the patient with adjustable support for the indicated areas while the patient is positioned in the chair 100. By positioning the speakers 112, inflatable pillows 114 and massage centers 116 within the chair 100, the chair is not only more aesthetically pleasing to the eye, but the ability to clean the chair surface after each patient procedure is made easier as there are no exposed surfaces of the speakers 112, inflatable pillows 114 or massage centers 116 in which foreign objects or matter could become lodged and unrecoverable. This allows the practitioner to easily clean the chair 100 and provide enhanced infection control. FIGS. 1 and 2 also depict the location and preferred placement of the control panel 118 for operating vibrating massage centers 116, inflatable support pillows 114, and audio speakers 112.

Turning to FIG. 3, the control panel 118 is depicted in closer detail. Control panel 118 may be located on either of the chair 100 armrests on any other surface which is easily accessible to the patient. The control panel 118 contains switches 120,122,124 which enable the patient to activate and control the massage centers 116, inflate and deflate the support pillows 114 and the adjust the volume of the sounds emitted from the speakers 112 placed within the chair headrest 102 as known in the art. It is recognized that various alternative embodiments of the massage centers 116 and support pillows 114 may be utilized with the disclosed invention wherein, for example, rolling vibratory massagers and heated inflatable pillows may be incorporated into the chair 100 disclosed herein. An example describing the use of the dental massage chair 100 embodiment disclosed herein is provided below.

Medical and dental personnel provide services to a wide array of patients on a daily basis. It goes without saying that different patients tolerate medical and dental procedures in many different ways. Some patients may become very nervous and anxious both before and during a medical or dental exam or treatment. Others may be completely oblivious without displaying any anxiety. One purpose of the disclosed invention is to use sensory stimulation to relieve a patient's stress and anxiety associated with medical or dental treatment. Providing a patient with a comfortable chair, relaxing massage and soothing audio allows the patient to become comfortable and relaxed while undergoing treatment. At the same time, the practitioner is able to perform the procedure with few, if any, interruptions from an anxious patient.

Prior to the initiation of a dental procedure, a patient is placed in the chair 100 and then uses the switches 120,122,124 located on control panel 118 to select and activate the speakers 112, inflatable pillows 114 and massage centers 116 which he or she wishes to function. For example, the patient may select an audio station or recorded media for playback during the procedure and control the volume associated therewith emitted from audio speakers 112 so as to diminish the sound of the instrumentation used by the practitioner during the procedure and receive soothing auditory sensory input to the patient. Likewise, the patient may inflate or deflate the various support pillows 114 to provide comfortable support to the patient's neck, lumbar and knee regions while the patient is positioned in the chair 100. The support pillows 114 may also be configured with a heating element that can provide warmth to the patient resting in the chair 100. Finally, the patient may activate the various massage centers 116 to provide a soothing massage to the patient's shoulders, lower back, buttocks, thighs, knees and calve areas while the patient is resting in the chair 100. The functions of these devices are controlled by the patient through manipulation of switches 120,122,124 located on control panel 118.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A dental examination chair for providing sensory stimulation to a patient comprising:
a dental chair with a headrest, backrest, armrest and leg rest support portions for supporting a patient undergoing a dental procedure;
an audio speaker positioned within the headrest of the chair;
a support pillow located within the backrest portion of the chair; and,
a massage center positioned within the backrest portion of the chair.

2. The dental examination chair of claim 1 further comprising:
at least one massage center positioned within the leg rest portion of the chair.

3. The dental examination chair of claim 1 further comprising:
at least one support pillow positioned within the leg rest portion of the chair.

4. The dental examination chair of claim 1 further comprising:
a patient control panel attached to at least one armrest portion of the chair allowing for patient control of the massage center, pillow inflation and volume of the audio speaker.

5. The dental examination chair of claim 1 wherein at least one support pillow is a heated support pillow.

6. A method for providing soothing, sensory stimulation to a patient undergoing a dental procedure, comprising:
placing a patient in a dental examination chair with at least one massage center, at least one audio speaker, and at least one inflatable pillow contained within the chair;
activating the massage center; and,
controlling the massage center output via a control pad.

7. The method of claim 6 further comprising:
activating the audio speaker; and,
controlling the volume output of the audio speaker via the control pad.

8. The method of claim 6 further comprising:
inflating or deflating the support pillow; and,
controlling the inflation and deflation of the support pillow via the control pad.
